(19) United States
(12) Patent Application Publication
(10) Pub. No.: US 2011/0126566 A1
(43) Pub. Date: Jun. 2, 2011

(54) AIR-CONDITIONER FOR USE WITH TRAILER REFRIGERATION UNIT

(75) Inventors: Jerry D. Jones, El Dorado Springs, MO (US); Michael D. Hoffman, El Dorado Springs, MO (US); Darrell R. Hoffman, Stockton, MO (US)

(73) Assignee: Jerry D. Jones, El Dorado Springs, MO (US)

(21) Appl. No.: 12/627,258

(22) Filed: Nov. 30, 2009

(51) Int. Cl. B60H 1/32; F25D 19/00; F25B 1/00; F25B 43/02

(52) U.S. Cl. 62/239; 62/298; 62/498; 62/470

(57) ABSTRACT

A refrigerated freight vehicle includes a tractor truck with a cab interior, a trailer presenting a chamber, and a cooling system to refrigerate the chamber and cool the cab. The cooling system includes a powered compressor assembly, a trailer evaporator, and a truck evaporator, with the compressor assembly operable to circulate refrigerant through the evaporators.

### BACKGROUND

1. Field

The present invention relates generally to refrigeration systems. More specifically, embodiments of the present invention concern a refrigerated freight vehicle with a cooling system that refrigerates a vehicle trailer and cools a cab of the vehicle.

2. Discussion of Prior Art

Conventional highway vehicles are used to haul perishable goods in a refrigerated or frozen condition over long distances and include a refrigerated trailer towed by a tractor truck. Prior art refrigerated trailers include an enclosed trailer and a powered vapor-compression refrigeration system that operates independently of the tractor truck, i.e., the refrigeration system is self-powered. Furthermore, some prior art refrigerated trailers include two refrigerated chambers and a refrigeration system that maintains each chamber at a corresponding predetermined temperature by the refrigeration system.

Prior art highway vehicles with a refrigerated trailer are deficient and suffer from various limitations. For instance, conventional refrigerated haulers are unable to efficiently operate in a manner that meets stringent engine emissions requirements in certain states. In particular, emissions requirements dictate that the engine of the tractor truck be turned off when the hauler is parked for an extended period of time. For trucks with a conventional air-conditioning system powered by the truck engine, the air-conditioning system is turned off with the engine. Thus, the truck cab can become uncomfortably hot and humid when the truck is parked and the engine is not allowed to idle. Some prior art tractor trucks are constructed to comply with state emissions requirements by including an auxiliary air-conditioning system mounted to the truck frame that serves to cool the truck cab while the truck engine is turned off, but such auxiliary systems are expensive and require significant maintenance.

### SUMMARY

The following brief summary is provided to indicate the nature of the subject matter disclosed herein. While certain aspects of the present invention are described below, the summary is not intended to limit the scope of the present invention.

Embodiments of the present invention provide a cooling system that does not suffer from the problems and limitations of the prior art refrigeration systems set forth above.

A first aspect of the present invention concerns a refrigerated freight vehicle broadly including a tractor truck, a trailer, and a cooling system. The tractor truck presents a cab interior. The trailer presents a chamber, with the trailer being releasably attached to and operable to be towed by the tractor truck. The cooling system is mounted relative to the trailer to refrigerate the chamber and cool the cab. The cooling system includes a powered compressor assembly, a trailer evaporator, and a truck evaporator, with the compressor assembly operable to circulate refrigerant through the evaporators. The trailer evaporator is mounted to the trailer and fluidly communicates with the chamber. The truck evaporator is mounted to the tractor truck and fluidly communicates with the cab interior. The compressor assembly is mounted to one of the tractor truck and trailer. The cooling system includes refrigerant supply and return lines extending between and permitting refrigerant fluid flow between the compressor assembly and the evaporator mounted to the other of the tractor truck and trailer. The cooling system includes fluid connection assemblies fluidly connected to and permitting refrigerant fluid flow through the corresponding refrigerant lines. The fluid connection assemblies permit selective fluid disconnection of the compressor assembly and the evaporator mounted to the other of the tractor truck and trailer and thereby allow detachment of the tractor truck and trailer from each other.

A second aspect of the present invention concerns a cooling system operable to cool a cab interior of a tractor truck and refrigerate a chamber of a trailer. The cooling system broadly includes a first cooling assembly and a second cooling assembly. The first cooling assembly is operable to be mounted to one of the tractor truck and trailer. The first cooling assembly includes a compressor and expansion valve fluidly connected by refrigeration supply and return lines. The first cooling assembly includes a first evaporator in fluid communication with the refrigeration return line and a condenser in fluid communication with the refrigeration supply line. The second cooling assembly is fluidly connected to the first cooling assembly. The second cooling assembly includes a second evaporator, with the first evaporator operable to fluidly communicate with one of the cab interior and chamber and the second evaporator operable to fluidly communicate with the other of the cab interior and chamber. The second cooling assembly includes refrigerant supply and return lines that fluidly communicate with respective refrigeration lines. The refrigerant lines fluidly communicate with the second evaporator and permit refrigerant fluid flow between the second evaporator and first cooling assembly. The second cooling assembly further includes a valve fluidly connected to a respective refrigerant line to control refrigerant fluid flow between the refrigeration lines and the second evaporator and thereby selectively cool the other of the cab interior and chamber.

A third aspect of the present invention concerns a cooling kit operable to be fluidly connected to a refrigeration system. The refrigeration system includes a compressor and expansion valve fluidly connected by refrigeration supply and return lines. The refrigeration system includes a refrigerating evaporator in fluid communication with the refrigeration return line and a condenser in fluid communication with the refrigeration supply line. The cooling kit broadly includes a cooling evaporator, refrigerant supply and return lines, a valve, and an adjustable pressure regulator. The refrigerant supply and return lines are operable to fluidly communicate with respective refrigeration lines. The refrigerant lines fluidly communicate with the cooling evaporator and are operable to permit refrigerant fluid flow between the cooling evaporator and refrigeration system. The valve is fluidly connected to a respective refrigerant line to control refrigerant fluid flow between the refrigeration lines and the cooling evaporator. The fluid connection assemblies are fluidly connected to and permit refrigerant fluid flow through the corresponding refrigerant lines. The fluid connection assemblies permit selective fluid disconnection of the refrigeration system and the cooling evaporator. The adjustable pressure regulator is fluidly connected to the refrigerant return line to adjustably control refrigerant pressure in the cooling evaporator.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary perspective of a refrigerated freight vehicle constructed in accordance with a preferred embodiment of the present invention, with the freight vehicle including a tractor truck, a trailer, and a vehicle cooling system with a trailer refrigeration system and a truck cooling system;

FIG. 2 is a fragmentary perspective of vehicle cooling system shown in FIG. 1, showing a control unit of the truck cooling system, with the control unit including manual valves, solenoid valves, and an adjustable pressure regulator, showing the manual valves fluidly detached from supply and return lines extending to the trailer refrigeration system, and showing quick-coupled connector assemblies with male and female connectors detached from each other to fluidly disconnect the control unit from the truck evaporator;

FIG. 3 is a schematic view of the vehicle cooling system shown in FIG. 1, showing the trailer refrigeration system including a compressor assembly and an expansion valve fluidly connected by a supply side and a return side, with the return side including an evaporator, trailer oil separator, venturi nozzle, and return lines, and the supply side including a condenser, receiver tank, drier, and supply lines, and further showing the truck cooling system including the control unit, an evaporator, thermostat, truck oil separator, drier, expansion valve, supply and return lines, and quick-coupled connector assemblies; and

FIG. 4 is a fragmentary electrical schematic of the vehicle cooling system shown in FIGS. 1 and 3, showing solenoid valves of the control unit operably coupled to the thermostat and a fan switch of the evaporator, with a battery of the trailer refrigeration system providing electrical power to the control unit, thermostat, and fan switch.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

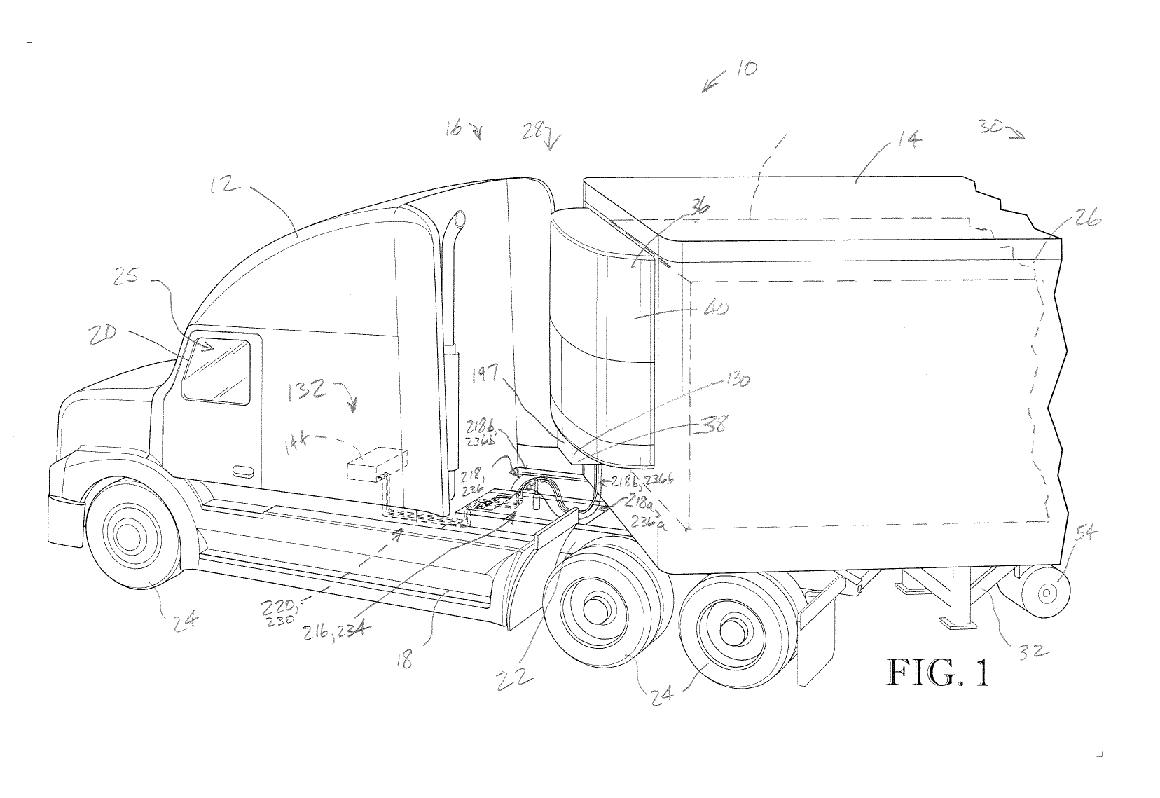

Turning initially to FIG. 1, a refrigerated freight vehicle 10 is operable to refrigerate or freeze perishable goods for transportation and provide air conditioning for a vehicle operator. As will be discussed in greater detail, the vehicle 10 includes a system that provides refrigeration of transported goods and selective cooling of the space occupied by the operator. The illustrated vehicle 10 broadly includes a tractor truck 12, an enclosed trailer 14, and a cooling system 16.

The truck 12 is conventional and includes a chassis 18, a cab 20 mounted on the chassis 18, and an engine (not shown) that powers the truck 12. The chassis 18 includes a frame 22 and wheels 24, with the frame 22 including a receiver (not shown) for connecting the truck 12 to the trailer 14. The cab 20 presents a climate-controlled cab interior 25.

The trailer 14 is also conventional and includes an enclosure 26 extending between fore and aft ends 28, 30 of the trailer 14. The trailer 14 further includes a frame 32 that extends longitudinally between the ends 28, 30 and supports the enclosure 26. The trailer 14 also includes wheels (not shown) mounted adjacent the aft end 30 and a hitch element (not shown) mounted adjacent the fore end 28. The hitch element is pivotally mounted to the receiver on the frame 22 to provide a pivotal towing joint that removably couples the truck 12 and trailer 14 to each other. The enclosure 26 defines a climate-controlled chamber 34 that receives goods and includes a door (not shown) to permit ingress and egress into and out of the chamber 34. The enclosure 26 is also insulated to limit heat transfer between the chamber 34 and ambient.

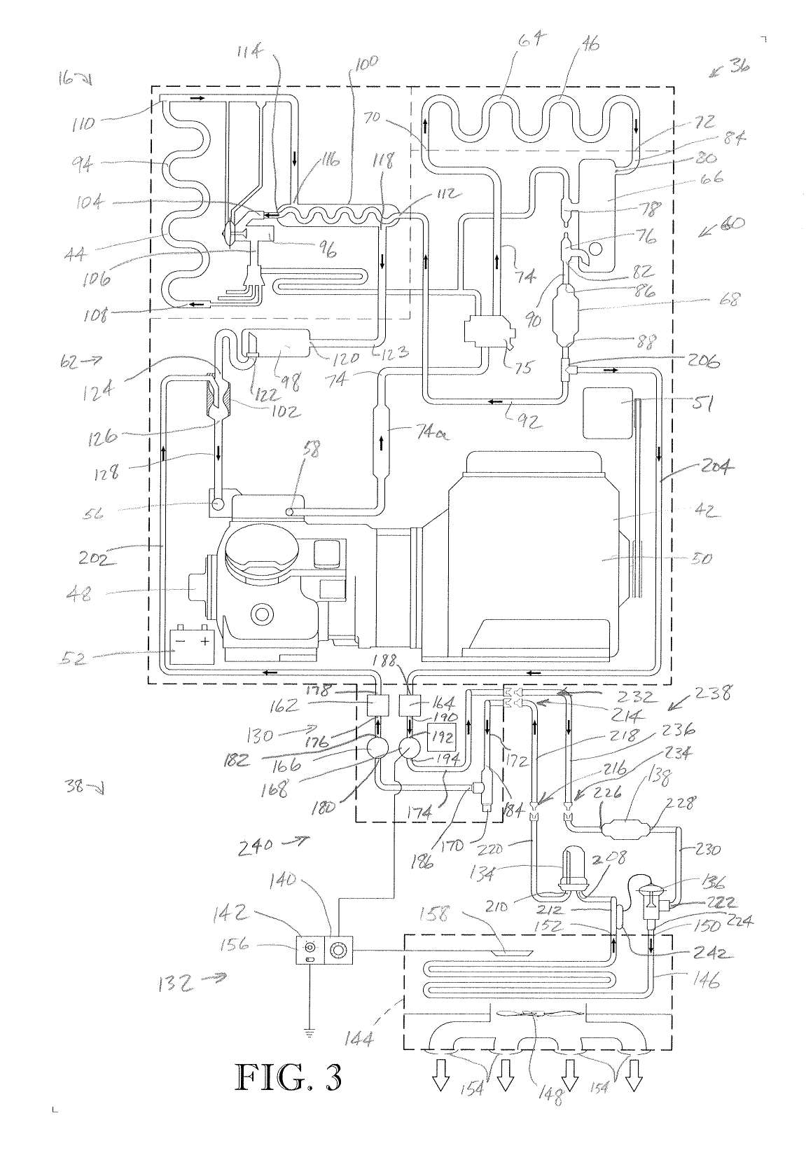

Turning to FIGS. 1 and 3, the cooling system 16 preferably comprises a vapor-compression refrigeration system. The illustrated cooling system 16 preferably includes a trailer refrigeration system 36 and a truck cooling system 38. The illustrated trailer refrigeration system 36 serves to refrigerate the enclosure chamber 34 and includes a housing 40 mounted to the fore end 28 of the enclosure 26, a compressor assembly 42, an evaporator assembly 44, and a condenser assembly 46. The compressor assembly 42 preferably includes a compressor 48 and an internal combustion engine 50 that powers the compressor 48, with the engine 50 including an alternator 51. The compressor assembly 42 further includes a battery 52 electrically coupled to the alternator 51 and a fuel tank 54, with the fuel tank 54 providing fuel to the engine 50 and being mounted outside of the housing 40 (see FIG. 1). However, the principles of the present invention are applicable where the compressor 48 is powered by an alternative engine, e.g., an electric motor. The compressor 48 is operated by a controller (not shown) and presents a compressor inlet 56 and compressor outlet 58. As will be discussed in greater detail, the trailer refrigeration system 36 presents a supply side 60 that receives pressurized refrigerant from the compressor 48 and extends between the compressor 48 and an expansion valve. The trailer refrigeration system 36 also presents a return side 62 that returns refrigerant to the compressor 48 and also extends between the expansion valve and the compressor 48. Refrigerant in the return side 62 is at a pressure that is generally lower than the pressure of refrigerant in the supply side 60.

The condenser assembly 46 discharges heat to ambient and includes a condenser coil 64, receiver tank 66 and drier 68. The condenser coil 64 is conventional and presents an inlet 70 and outlet 72, with the inlet 70 being fluidly connected to compressor outlet 58 by supply lines 74, including flexible line section 74a, and also by a valve 75. The receiver tank 66 includes a receiver outlet valve 76, bypass valve 78, and presents an inlet 80 and outlet 82. The receiver inlet 80 is fluidly connected to condenser outlet 72 by supply line 84. The dryer 68 removes moisture from the refrigerant fluid and presents inlet and outlet 86, 88. The dryer inlet 86 is fluidly connected to receiver outlet 82 by supply line 90 and the outlet 88 of dryer 68 is fluidly connected to the evaporator assembly 44 by supply line 92, as will be discussed. As will also be discussed, the condenser assembly 46 is preferably operable to provide refrigerant fluid to truck cooling system 38.

The evaporator assembly 44 fluidly communicates with the chamber 34 in the usual manner to remove heat from the chamber 34. The evaporator assembly 44 includes components that are associated with the return side 62 of the trailer refrigeration system 36. The evaporator assembly 44 broadly includes an evaporator coil 94, expansion valve 96, oil separator 98, heat exchanger 100, and venturi nozzle 102. In the usual manner, the expansion valve 96 serves to throttle refrigerant flow and cooperates with the compressor 48 to define the supply and return sides 60, 62. The expansion valve 96 presents an inlet 104 and outlet 106. The evaporator coil 94 is conventional and presents an inlet 108 and outlet 110, with the outlet 106 of the expansion valve being fluidly connected to the inlet 108 of the evaporator coil 94. A fan (not shown) is installed adjacent to the evaporator coil 94 and draws air through the evaporator coil 94 to cool the enclosure chamber 34.

The heat exchanger 100 comprises a refrigerant-to-refrigerant heat exchanger and presents a supply inlet 112 and supply outlet 114. The supply inlet 112 is fluidly connected to the dryer outlet 88 and the supply outlet 114 is fluidly connected to the expansion valve inlet 104. The heat exchanger 100 also presents a return inlet 116 and return outlet 118. The evaporator outlet 110 is fluidly connected to the return inlet 116. The oil separator 98 (i.e., accumulator) presents an inlet 120 and outlet 122, with the return outlet 118 being fluidly connected to the inlet 120 by a return line 123. The venturi nozzle 102 also presents an inlet 124 and outlet 126, with the inlet 124 being connected to the oil separator outlet 122 and the venturi outlet 126 being connected to the compressor inlet 56 by a flexible return line 128. It is also within the scope of the present invention where the venturi nozzle 102 is alternatively located between the evaporator coil 94 and the compressor inlet 56 (e.g., where the venturi nozzle 102 is located upstream of the oil separator 98). Furthermore, for some aspects of the present invention, the trailer refrigeration system 36 could be devoid of the venturi nozzle 102.

Components upstream of the expansion valve 96 and downstream of the compressor outlet 58 cooperatively define the supply side 60 of the trailer refrigeration system 36. More specifically, refrigerant primarily in vapor phase flows from the compressor 48 through flexible supply line 74, valve 75, and through condenser coil 64. Refrigerant is discharged from the condenser coil 64 in a primarily liquid phase and flows through receiver tank 66, outlet valve 76, and drier 68. At least some of the refrigerant continues to flow directly toward expansion valve 96. As will be discussed in greater detail, some of the refrigerant flowing out of drier 68 can be diverted to the truck cooling system 38.

Similarly, components of the evaporator assembly 44 downstream of the expansion valve 96 cooperatively define the return side 62 of the trailer refrigeration system 36. In particular, two-phase liquid-vapor refrigerant flows from the expansion valve 96 and through the evaporator coil 94 and exits as primarily vapor. Refrigerant then flows through heat exchanger 100, the oil separator 98, the venturi nozzle 102, and returns to the compressor inlet 56. In addition, some refrigerant can be returned to the return side 62 from the truck cooling system 38.

The illustrated trailer refrigeration system 36 preferably comprises a Single Temp Trailer System manufactured by Thermo King Corporation that has been modified to be operably coupled to the cooling system 38, i.e., by inserting the venturi nozzle 102 and attaching a tee adjacent the drier 68. However, the principles of the present invention are applicable where system 36 is alternatively constructed. While the illustrated system 36 is modular and is mounted entirely on trailer 14, some components of system 36 could also be mounted on truck 12. For example, the system 36 could be constructed such that the compressor assembly 42 and condenser assembly 46 are mounted on truck 12, with components of the evaporator assembly 44 being mounted on the trailer 14.

The illustrated trailer refrigeration system 36 preferably is operable to cool the chamber 34 of enclosure 26. However, for some aspects of the present invention, a system similar to trailer refrigeration system 36 could be installed to provide cooling to truck 12, e.g. where the refrigeration system 36 is mounted to truck 12 and cooling system 38 is mounted to trailer 14.

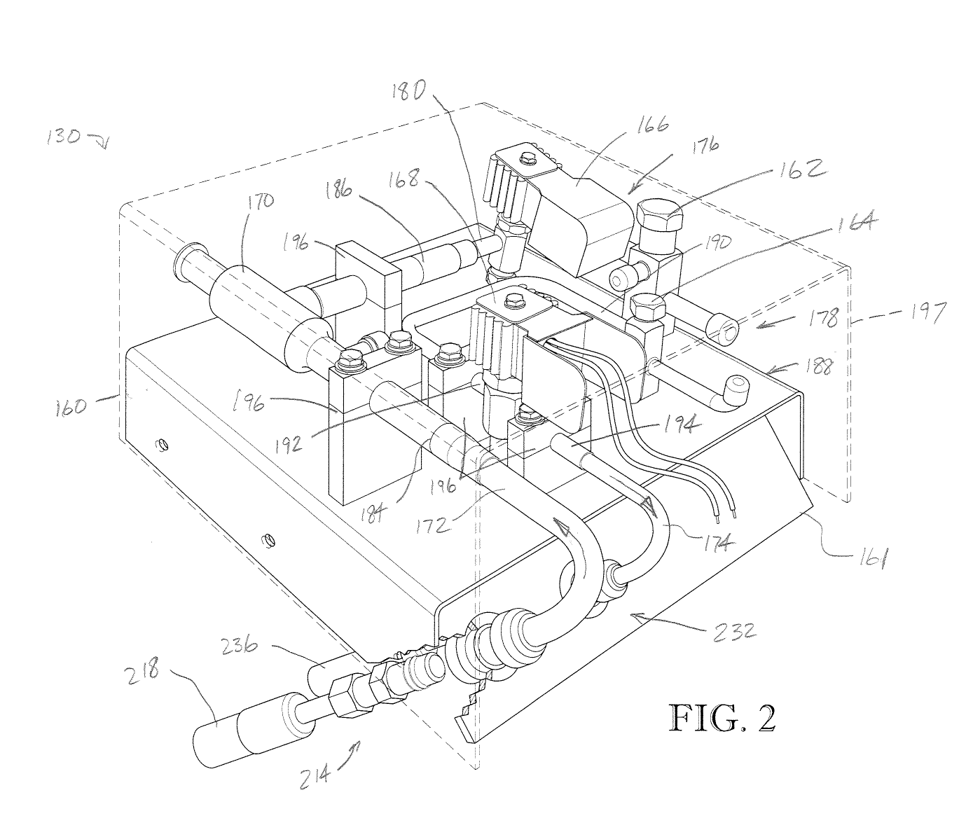

Turning to FIGS. 2-4, the truck cooling system 38 uses refrigerant from the trailer refrigeration system 36 to cool the cab 20. The truck cooling system 38 broadly includes a control unit 130, truck evaporator assembly 132, oil separator 134, expansion valve 136, drier 138, and thermostat 140. The evaporator assembly 132 preferably includes a fan switch 142, housing 144, evaporator coil 146, and powered fan 148. The evaporator coil 146 presents an inlet 150 and outlet 152 and fluidly communicates with the trailer refrigeration system 36, as will be discussed. The housing 144 receives the evaporator coil 146 and presents air outlets 154, with the powered fan 148 also being mounted within the housing 144 to draw air through the evaporator coil 146 and discharge chilled air through the outlets 154. The illustrated evaporator assembly 132 preferably comprises a Ductable Air-Conditioning Unit, Model No. R-2100, manufactured by Red Dot Corporation. The evaporator assembly 132 is preferably mounted within the cab interior 25, e.g., within a sleeper section of the cab 20, and fluidly communicates with the cab interior 25 to cool the entire cab 20 (see FIG. 1).

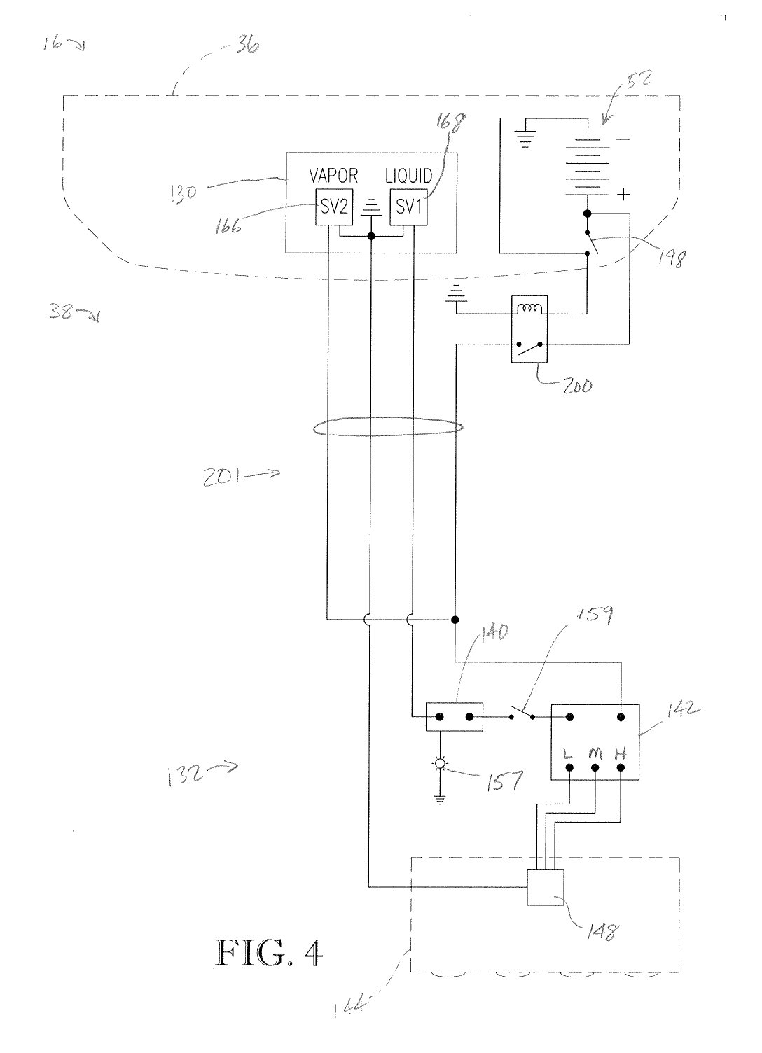

The thermostat 140 includes a thermostat control 156, a pilot light 157, and a temperature sensor 158. The illustrated thermostat 140 preferably comprises a Universal Thermostat, Model No. UT 72, manufactured by Danfoss Corporation, although another thermostat could be installed. The thermostat 140 is also operably coupled to the control unit 130 to selectively permit refrigerant flow between the control unit 130 and the evaporator assembly 132, as will be discussed. The thermostat 140 is electrically coupled to and receives power from the fan switch 142 through a toggle switch 159 (see FIG. 4). Thus, the thermostat 140 receives power when the toggle switch 159 is engaged.

The fan switch 142 is electrically coupled to and powers the fan 148. The fan switch 142 preferably includes three discrete fan speed settings L, M, H. The three settings are each associated with a corresponding one of three fan speeds (i.e., low, medium, and high fan speeds). The fan switch 142 is electrically coupled to and receives power entirely from the battery 52 and engine alternator 51 by engaging a power switch and relay, as will be discussed. The illustrated thermostat 140 and fan switch 142 are preferably mounted in the cab interior 25 to be accessed by an operator within the cab 20.

Turning to FIGS. 2 and 3, the control unit 130 permits selective refrigerant flow between the evaporator assembly 132 and the trailer refrigeration system 36. The control unit 130 broadly includes a housing 160 including a base 161, return and supply manual valves 162, 164, return and supply solenoid valves 166, 168, an adjustable pressure regulator 170, and return and supply lines 172, 174. The manual valves 162, 164 preferably comprise Model Nos. QL171R-08-08 and QL171R-06-06 manufactured by Parker Hannifin Corporation. The solenoid valves 166, 168 preferably comprise normally-closed solenoid valves, Model Nos. 530-665XS and 530-407X manufactured by the Sporlan Division of Parker Hannifin Corporation. The pressure regulator 170 preferably comprises an adjustable pressure regulator, Model No. 531-360X, manufactured by the Sporlan Division of Parker Hannifin Corporation.

The return manual valve 162 presents inlet and outlet 176, 178 and the return solenoid valve 166 presents inlet and outlet 180, 182, with the outlet 182 fluidly connected to inlet 176. The outlet 178 of manual valve 162 is fluidly connected to the trailer refrigeration system 36. The pressure regulator 170 presents inlet and outlet 184, 186, with the outlet 186 fluidly connected to inlet 180 of the solenoid valve 166 and the inlet 184 fluidly connected to return line 172 and the evaporator assembly 132, as will be discussed.

The adjustable pressure regulator 170 serves to control the temperature of the evaporator coil by maintaining pressure of refrigerant flow through the evaporator coil 146. Specifically, the pressure regulator 170 provides a variable pressure setting that establishes a predetermined minimum pressure in the evaporator coil 146. In this manner, the pressure regulator 170 restricts the evaporator coil 146 from freezing by maintaining the minimum pressure in the evaporator coil 146, particularly during low load conditions.

The supply manual valve 164 presents inlet and outlet 188, 190 and supply solenoid valve 168 presents inlet and outlet 192, 194, with the outlet 190 fluidly connected to inlet 192. The inlet 188 of manual valve 164 is fluidly connected to the trailer refrigeration system 36. The outlet 194 of solenoid valve 168 is fluidly connected to supply line 174 and evaporator assembly 132, as will be discussed. The illustrated fluid connection of components within the control unit 130 is preferred. However, for some aspects of the present invention, the control unit 130 could be alternatively configured. For instance, the control unit 130 could include an alternative valve arrangement for selectively controlling refrigerant flow between the trailer refrigeration system 36 and truck cooling system 38.

The manual valves 162, 164 are attached directly to an upper surface of base 161. The valves 162, 164, 166, 168 and pressure regulator 170 are also secured above the base 161 by mounts 196 and are enclosed and protected by cover 197, which is removably attached to the base 161. Thus, the illustrated control unit 130 preferably has a modular construction that permits components of the control unit 130 to be installed as an aftermarket kit onto the refrigeration system 36. However, the principles of the present invention are applicable where the components of control unit 130 are alternatively installed, e.g., where the components are mounted within the housing 40 of the trailer refrigeration system 36.

Turning again to FIGS. 2-4, the return solenoid valve 166 is preferably electrically coupled to battery 52 by a unit power switch 198, a 12-volt relay 200, and a wire of electrical wire harness 201. Thus, the step of engaging the power switch 198 engages the relay 200, which consequently energizes and opens the solenoid valve 166. The supply solenoid valve 168 is electrically coupled to and receives power from the thermostat 140 via electrical wire harness 201. Thus, when the thermostat 140 senses temperature above the temperature setting, the thermostat 140 energizes and opens the solenoid valve 168.

The control unit 130 is fluidly connected to the trailer refrigeration system 36 by return and supply lines 202, 204, with supply line 204 extending from tee 206 adjacent the dryer 68 to the inlet 188 of manual valve 164. The tee 206 is preferably located downstream of dryer 68, but could be located elsewhere between the condenser coil 64 and the expansion valve 96. Return line 202 preferably extends from the outlet 178 of manual valve 162 to the venturi nozzle 102, with an outlet of the return line 202 being positioned in fluid communication with the venturi nozzle 102.

It has been found that the illustrated venturi nozzle arrangement permits continuous operation of the truck cooling system 38, particularly when the evaporator coil 94 of the trailer refrigeration system 36 is being defrosted. A defrost cycle of the trailer refrigeration system 36 generally lasts about 15 minutes. A defrost cycle can occur periodically, e.g., once every 3 hours, or in response to a sensed condition, such as pressure drop across the evaporator. During the defrost cycle, the refrigerant pressure within the return side 62 has been found to be generally about 100 psi. The refrigerant operating pressure within the return line 202 is generally about 50 psi, or about half as much as the refrigerant pressure in return side 62. The illustrated venturi nozzle 102 is constructed so that refrigerant flow velocity increases through the nozzle 102, which lowers the refrigerant pressure within the nozzle 102 compared to other locations along the return side 62. Preferably, refrigerant pressure within the nozzle 102 is less than refrigerant pressure in return line 202 (e.g., less than 50 psi) so that compressor 48 draws refrigerant from the truck cooling system 38. However, for some aspects of the present invention, the trailer refrigeration system 36 could be devoid of a venturi nozzle, e.g., where the return line 202 is fluidly connected to the evaporator assembly 44 by a tee (not shown).

As discussed above, the control unit 130 is operably and fluidly connected to the evaporator assembly 132. In particular, the oil separator 134 (i.e., accumulator) is fluidly connected between the evaporator outlet 152 and return line 172. The oil separator 134 serves to remove oil from the refrigerant flow discharged by the evaporator coil 146 and presents an inlet and outlet 208, 210. The inlet 208 of the oil separator 134 is fluidly connected to the evaporator coil 146 by return line 212 and the outlet 210 is fluidly connected to the return line 172 by quick-coupled bulkhead connector assemblies 214, 216 and flexible return line 218 and return line 220, which is preferably rigid. The connector assemblies 214, 216 are each conventional and each include complemental male and female quick-coupled connectors that are selectively connectable to each other to permit refrigerant fluid flow through lines 218, 220. The male and female connectors preferably comprise stainless steel High Pressure 2-Way Shut-Off hydraulic fittings, Model No. FHK, manufactured by Foster Manufacturing Company.

The flexible return line 218 preferably extends from connector assembly 214 adjacent the control unit 130 in a generally forward direction to connector assembly 216 and is preferably supported by the frame 22 in a location spaced rearwardly of the cab 20. The return line 218 comprises a flexible conduit and presents a length that is greater than the distance between the connector assemblies 214, 216. Thus, the construction and length of the flexible return line 218 permits relative pivotal movement between the truck 12 and trailer 14. In addition, the length of the return line 218 causes the return line 218 to assume a coiled or serpentine shape when installed and supported above the frame 22 such that an intermediate lower section 218a of line 218 is located between elevated adjacent sections 218b that are relatively higher than the lower section (see FIG. 1). It has been found that the illustrated serpentine line shape can cause liquid to be trapped in the line 218 along the intermediate lower section 218a of the line 218.

In addition, the serpentine shape of line 218 can result in liquid being trapped along a section of line 220, particularly because the illustrated line 220 is located below the elevated adjacent section 218b of line 218 and below the evaporator assembly 132. Furthermore, liquid can accumulate until refrigerant forces a slug of the liquid into the compressor 48, which can damage the compressor 48. The illustrated oil separator 134 is preferably mounted under the cab 20 and evaporator coil 146 and positioned adjacent the evaporator coil 146 downstream of lower line sections (such as section 218a) that may collect liquid. It has been discovered that this positioning of the oil separator 134 restricts liquid from collecting in flexible return line 218 and return line 220 and also restricts liquid from being returned to the compressor 48.

The expansion valve 136 and drier 138 are fluidly connected between the evaporator inlet 150 and supply line 174. The expansion valve 136 throttles refrigerant flow into the evaporator coil 146 and presents inlet and outlet 222, 224. The illustrated expansion valve 136 preferably comprises a thermostatic expansion valve, Model No. T2, manufactured by Danfoss Corporation, although another expansion valve could be installed without departing from the scope of the present invention. Preferably, the inlet 222 is fluidly connected to the drier 138 and the outlet 224 is fluidly connected to evaporator inlet 150.

The drier 138 removes moisture from the refrigerant flow through corresponding refrigerant supply lines and presents inlet and outlet 226, 228. The illustrated drier 138 preferably comprises a DCL Eliminator™ Liquid Line Filter-Drier manufactured by Danfoss Corporation, although another drier could be installed consistent with the present invention. The outlet 228 of drier 138 is fluidly connected to inlet 222 by supply line 230. The inlet 226 is fluidly connected to supply line 174 by quick-coupled connector assemblies 232, 234 and flexible supply line 236, which fluidly interconnects connector assemblies 232, 234. The connector assemblies 232, 234 are conventional and each include complemental male and female quick-coupled connectors that are selectively connectable to each other to permit refrigerant fluid flow through lines 230, 236. The male and female connectors preferably comprise stainless steel High Pressure 2-Way Shut-Off hydraulic fittings, Model No. FHK, manufactured by Foster Manufacturing Company.

The illustrated connector assemblies 214, 216, 232, 234 preferably permit selective fluid disconnection of the control unit 130 and the evaporator assembly 132. In this manner, the illustrated arrangement of connector assemblies 214, 216, 232, 234 also permits selective fluid disconnection of the evaporator assembly 132 and the trailer refrigeration system 36, particularly to permit decoupling of the towing joint between the trailer 14 from the truck 12. However, the principles of the present invention are also applicable where quick-coupled connectors are alternatively located to allow selective fluid connection of the evaporator assembly 132 and trailer refrigeration system 36. For instance, quick-coupled connectors could be installed along lines 202, 204 to fluidly disconnect control unit 130 from the trailer refrigeration system 36 and thereby permit selective decoupling of the trailer 14 from the truck 12. Also, the truck cooling system 38 could include only the connector assemblies 214, 216 adjacent the control unit 130.

Similar to return line 218, flexible supply line 236 preferably extends from connector assembly 232 adjacent the control unit 130 in a generally forward direction to connector assembly 234 and is preferably supported by the frame 22 at a location spaced rearwardly of the cab 20. The supply line 236 also comprises a flexible conduit and presents a length that is greater than the distance between the connector assemblies 232, 234. The construction and length of the flexible supply line 236 permits relative pivotal movement between the truck 12 and trailer 14. Again, the length of the supply line 236 causes the supply line 236 to assume a coiled or serpentine shape when installed and supported above the frame 22 such that an intermediate lower section 236a of line 236 is located between elevated adjacent sections 236b that are relatively higher than the lower section (see FIG. 1). It has been found that the illustrated serpentine line shape can cause liquid to be trapped in the line 236 along the intermediate lower section 236a of the line 236.

The serpentine shape of line 236 can result in liquid being trapped along a section of line 230, particularly because the illustrated line 230 is located below the elevated adjacent section 236b of line 236 and below the evaporator assembly 132. Thus, liquid can accumulate until refrigerant forces a slug of the liquid to flow toward the compressor 48. In the event a liquid slug is forced from lines 230, 236, the oil separator 134 is positioned to collect the liquid slug and restrict liquid transmission to the compressor.

Again, the drier 138 is operable to remove moisture from the refrigerant circulated through the truck cooling system 38, and is preferably positioned adjacent the evaporator coil 146. The expansion valve 136 throttles refrigerant flow and includes a sensor bulb 242. The expansion valve 136 is preferably positioned adjacent the inlet 150 of the evaporator coil 146 and downstream of the drier 138.

Thus, the illustrated truck cooling system 38 presents a supply side 238 that extends from the tee 206 to the inlet 222 of the expansion valve 136 and a return side 240 that extends from the outlet 224 of the expansion valve 136 to the venturi nozzle 102. Pressurized refrigerant in primarily liquid phase flows from condenser assembly 46 to control unit 130 through supply line 204. Manual and solenoid valves 164, 168 selectively allow liquid refrigerant to flow through the drier 138 to the expansion valve 136, where the refrigerant expands to the evaporator pressure.

Refrigerant continues from the expansion valve 136 along the return side 240 in a two-phase liquid-vapor form. Refrigerant passes through the evaporator coil 146, with heat being received by the refrigerant from the cab interior 25. Refrigerant primarily in the form of vapor flows from the evaporator coil 146, through the oil separator 134, and through the adjustable pressure regulator 170. Manual and solenoid valves 162, 166 selectively allow vapor refrigerant to flow into return line 202 and into the venturi nozzle 102.

In operation, the trailer refrigeration system 36 maintains the enclosure chamber 34 and any goods within the chamber 34 at a predetermined temperature. The operator can selectively power the truck cooling system 38 by initially engaging the power switch 198 to provide power to fan switch 142. The step of powering the cooling system 38 energizes and thereby opens supply solenoid valve 168. The fan 148 is operable to be turned on by adjusting the fan switch 142 between one of the three fan speed settings L, M, H. The thermostat 140 is operable to control the temperature of the cab 20 by engaging the toggle switch 159 so that the thermostat 140 receives electrical power from the fan switch 142. In addition, the operator can adjust the thermostat control knob to select the preset thermostat temperature. When the temperature sensed by the thermostat 140 is above the preset thermostat temperature, the thermostat 140 energizes and thereby opens return solenoid valve 166.

With both solenoid valves 166, 168 engaged and open, refrigerant is operable to flow between the trailer refrigeration system 36 and the truck cooling system 38 so that heat from the cab 20 is received by the refrigerant, returned to the refrigeration system 36, and then discharged to ambient. Once the cab interior has cooled to the preset thermostat temperature, the thermostat 140 cuts off power to the return solenoid valve 166 and thereby closes the return solenoid valve 166, which stops the flow of refrigerant through the cooling system 38.

The truck cooling system 38 is selectively disengaged by disengaging toggle switch 159, which prevents the return solenoid valve 166 from being opened. The fan 148 is operable to be turned off by shifting the fan switch 142 to an off position. In addition, the power switch 198 can be disengaged to prevent transmission of electrical power to the fan switch 142.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A refrigerated freight vehicle comprising:
a tractor truck presenting a cab interior;
a trailer presenting a chamber, with the trailer being releasably attached to and operable to be towed by the tractor truck; and
a cooling system mounted relative to the trailer to refrigerate the chamber and cool the cab,
said cooling system including a powered compressor assembly, a trailer evaporator, and a truck evaporator, with the compressor assembly operable to circulate refrigerant through the evaporators,
said trailer evaporator mounted to the trailer and fluidly communicating with the chamber,
said truck evaporator mounted to the tractor truck and fluidly communicating with the cab interior,
said compressor assembly being mounted to one of the tractor truck and trailer,
said cooling system including refrigerant supply and return lines extending between and permitting refrigerant fluid flow between the compressor assembly and the evaporator mounted to the other of the tractor truck and trailer,
said cooling system including fluid connection assemblies fluidly connected to and permitting refrigerant fluid flow through the corresponding refrigerant lines,
said fluid connection assemblies permitting selective fluid disconnection of the compressor assembly and the evaporator mounted to the other of the tractor truck and trailer and thereby allowing detachment of the tractor truck and trailer from each other.

2. The refrigerated freight vehicle as claimed in claim 1,
said cooling system including an oil separator in fluid communication with the refrigerant return line to remove oil from refrigerant fluid flowing through the refrigerant return line.

3. The refrigerated freight vehicle as claimed in claim 2,
said cooling system including a drier in fluid communication with the refrigerant supply line to remove moisture from refrigerant fluid flowing through the refrigerant supply line.

4. The refrigerated freight vehicle as claimed in claim 2,
said cooling system including a thermostat operably coupled to the truck evaporator to selectively control temperature in the cab interior.

5. The refrigerated freight vehicle as claimed in claim 4,
said cooling system including a solenoid valve in fluid communication with the refrigerant supply line to selectively prevent refrigerant fluid from flowing through the refrigerant supply line,
said thermostat operably coupled to the solenoid valve to open or close the solenoid valve and thereby selectively permit refrigerant fluid flow through the truck evaporator.

6. The refrigerated freight vehicle as claimed in claim 1,
said cooling system including a first solenoid valve in fluid communication with the refrigerant supply line and a second solenoid valve in fluid communication with the refrigerant return line.

7. The refrigerated freight vehicle as claimed in claim 1,
said cooling system including an expansion valve fluidly connected to the compressor assembly by refrigeration supply and return lines,
one of the evaporators being in fluid communication with the refrigeration lines, with the other evaporator in fluid communication with the refrigerant lines.

8. The refrigerated freight vehicle as claimed in claim 7,
said cooling system including a venturi nozzle in fluid communication with the refrigeration return line,
said refrigerant return line presenting an outlet positioned in and fluidly communicating with the venturi nozzle.

9. The refrigerated freight vehicle as claimed in claim 1,
said cooling system including an adjustable pressure regulator fluidly connected to the refrigerant return line to adjustably control refrigerant pressure in the evaporator mounted to said other of the tractor truck and trailer.

10. The refrigerated freight vehicle as claimed in claim 1,
said compressor assembly being mounted to the trailer, with the fluid connection assemblies permitting selective fluid disconnection of the compressor assembly and the truck evaporator.

11. A cooling system operable to cool a cab interior of a tractor truck and refrigerate a chamber of a trailer, said cooling system comprising:
a first cooling assembly operable to be mounted to one of the tractor truck and trailer,
said first cooling assembly including a compressor and expansion valve fluidly connected by refrigeration supply and return lines,
said first cooling assembly including a first evaporator in fluid communication with the refrigeration return line and a condenser in fluid communication with the refrigeration supply line; and
a second cooling assembly fluidly connected to the first cooling assembly,
said second cooling assembly including a second evaporator, with the first evaporator operable to fluidly communicate with one of the cab interior and chamber and the second evaporator operable to fluidly communicate with the other of the cab interior and chamber,
said second cooling assembly including refrigerant supply and return lines that fluidly communicate with respective refrigeration lines,
said refrigerant lines fluidly communicating with the second evaporator and permitting refrigerant fluid flow between the second evaporator and first cooling assembly,
said second cooling assembly further including a valve fluidly connected to a respective refrigerant line to control refrigerant fluid flow between the refrigeration lines and the second evaporator and thereby selectively cool the other of the cab interior and chamber.

12. The cooling system as claimed in claim 11; and
an oil separator in fluid communication with the refrigerant return line to remove oil from refrigerant fluid flowing through the refrigerant return line.

13. The cooling system as claimed in claim 12; and
a drier in fluid communication with the refrigerant supply line to remove moisture from refrigerant fluid flowing through the refrigerant supply line.

14. The cooling system as claimed in claim 12; and
a thermostat operably coupled to the second evaporator to selectively control temperature in the cab interior.

15. The cooling system as claimed in claim 14; and
a solenoid valve in fluid communication with the refrigerant supply line to selectively prevent refrigerant fluid from flowing through the refrigerant supply line,
said thermostat operably coupled to the solenoid valve to open or close the solenoid valve and thereby selectively permit refrigerant fluid flow through the second evaporator.

16. The cooling system as claimed in claim 11; and
a first solenoid valve in fluid communication with the refrigerant supply line and a second solenoid valve in fluid communication with the refrigerant return line.

17. The cooling system as claimed in claim 11,
said first cooling assembly including an expansion valve fluidly connected to the compressor by the refrigeration supply and return lines.

18. The cooling system as claimed in claim 17; and
a venturi nozzle in fluid communication with the refrigeration return line,
said refrigerant return line presenting an outlet positioned in and fluidly communicating with the venturi nozzle.

19. The cooling system as claimed in claim 11; and
fluid connection assemblies fluidly connected to and permitting refrigerant fluid flow through the corresponding refrigerant lines,
said fluid connection assemblies permitting selective fluid disconnection of the compressor assembly and the second evaporator.

20. The cooling system as claimed in claim 1; and
an adjustable pressure regulator fluidly connected to the refrigerant return line to adjustably control refrigerant pressure in the second evaporator.

21. A cooling kit operable to be fluidly connected to a refrigeration system, said refrigeration system including a compressor and expansion valve fluidly connected by refrigeration supply and return lines, said refrigeration system including a refrigerating evaporator in fluid communication with the refrigeration return line and a condenser in fluid communication with the refrigeration supply line, said cooling kit comprising:
a cooling evaporator;
refrigerant supply and return lines operable to fluidly communicate with respective refrigeration lines,
said refrigerant lines fluidly communicating with the cooling evaporator and operable to permit refrigerant fluid flow between the cooling evaporator and refrigeration system;
a valve fluidly connected to a respective refrigerant line to control refrigerant fluid flow between the refrigeration lines and the cooling evaporator;
fluid connection assemblies fluidly connected to and permitting refrigerant fluid flow through the corresponding refrigerant lines,
said fluid connection assemblies permitting selective fluid disconnection of the refrigeration system and the cooling evaporator; and
an adjustable pressure regulator fluidly connected to the refrigerant return line to adjustably control refrigerant pressure in the cooling evaporator.

22. The cooling kit as claimed in claim 21; and
an oil separator in fluid communication with the refrigerant return line to remove oil from refrigerant fluid flowing through the refrigerant return line.

23. The cooling kit as claimed in claim 22; and
a drier in fluid communication with the refrigerant supply line to remove moisture from refrigerant fluid flowing through the refrigerant supply line.

24. The cooling kit as claimed in claim 22; and
a thermostat operably coupled to the cooling evaporator to selectively control evaporator temperature.

25. The cooling kit as claimed in claim 24; and
a solenoid valve in fluid communication with the refrigerant supply line to selectively prevent refrigerant fluid from flowing through the refrigerant supply line,
said thermostat operably coupled to the solenoid valve to open or close the solenoid valve and thereby selectively permit refrigerant fluid flow through the cooling evaporator.

26. The cooling kit as claimed in claim 21; and
a first solenoid valve in fluid communication with the refrigerant supply line and a second solenoid valve operably coupled to the refrigerant return line.

27. The cooling kit as claimed in claim 21; and
a venturi nozzle operable to be in fluid communication with the refrigeration return line,
said refrigerant return line presenting an outlet positioned in and fluidly communicating with the venturi nozzle.

28. The cooling kit as claimed in claim 21; and
fluid connection assemblies fluidly connected to and permitting refrigerant fluid flow through the corresponding refrigerant lines,
said fluid connection assemblies permitting selective fluid disconnection of the compressor assembly and the second evaporator.
